(19) United States
(12) Patent Application Publication
(10) Pub. No.: US 2012/0130745 A1
(43) Pub. Date: May 24, 2012

(54) SYSTEM, METHOD, AND COMPUTER-READABLE MEDIUM FOR DELIVERING RELEVANT MEDICAL INFORMATION

(76) Inventor: Steven Jones, West Lafayette, IN (US)

(21) Appl. No.: 13/304,595

(22) Filed: Nov. 25, 2011

Related U.S. Application Data
(60) Provisional application No. 61/417,016, filed on Nov. 24, 2010.

(51) Int. Cl. G06Q 50/24

(52) U.S. Cl. 705/3

(57) ABSTRACT

A system, method, and computer-readable medium for delivering relevant medical information are disclosed. Such a method for delivering relevant medical information includes determining that a medical order has been scheduled or completed for a patient, identifying the patient that is the subject of the medical order, finding prior medical records of the patient, automatically determining relevant medical records from the prior medical records of the patient based upon the medical order, and delivering the relevant medical records to one or more remote computers.

### CROSS REFERENCE TO RELATED APPLICATIONS

This patent application claims the benefit of and incorporates by reference herein the disclosure of U.S. Ser. No. 61/417,016, filed Nov. 24, 2010.

### BACKGROUND

In order to provide high quality diagnosis, it is often necessary for medical professionals to have prior medical information of a patient while analyzing a current study or exam for the patient. For example, a radiologist typically would benefit from having one or more prior films of a certain body part or portion of the body to compare against a current film of the same part of the body in order to make a diagnosis. Unfortunately, the systems and processes in use today by medical institutions frequently fail to provide medical professionals with relevant prior medical studies at the time they are needed. This is especially true when those relevant prior studies are at other institutions.

Even though some medical records are now stored electronically, there are still significant problems with quickly providing a medical professional with relevant prior medical studies. For example, a comparison study that is stored at a medical institution that is different than the requesting medical professional's medical institution would need to be either brought to the new facility by the patient (e.g., CD), fetched by a courier, or pushed electronically from one institution to another. Each of these options requires time consuming actions, such as calling in a request and searching a database for the prior medical studies. Of course, after the time-consuming process of retrieving prior medical studies is complete, the medical professional must then sort through all of the studies to determine which are relevant to the present study. Because of the time required to retrieve medical information and determine relevancy of the retrieved information, medical professionals are forced to focus on these tasks instead of carrying out their real role of providing medical diagnosis and care.

Accordingly, there exists a need for a way of delivering relevant medical information to medical professionals in a relatively short period of time.

### SUMMARY

The present disclosure discloses a system, method, and computer-readable medium for delivering relevant medical information. In one embodiment, such a method for delivering relevant medical information includes determining that a medical order has been scheduled or completed for a patient, identifying the patient that is the subject of the medical order, finding prior medical records of the patient, automatically determining relevant medical records from the prior medical records of the patient based upon the medical order, and delivering the relevant medical records to one or more remote computers.

In another embodiment, such a method for delivering relevant medical information includes selecting a patient for analysis, selecting a medical order, retrieving prior medical records of the patient, automatically determining relevant prior medical records from the retrieved prior medical records based upon the selected patient and the selected medical order, and delivering the relevant prior medical records to a destination.

In one embodiment, such a computer-readable medium includes a computer program for delivering relevant medical information where the computer-readable medium includes code portions stored therein. The computer-readable medium code portions include a first executable portion for selecting a patient for analysis, a second executable portion for selecting one or more prior medical orders, a third executable portion for retrieving prior medical records of the patient, a fourth executable portion for determining relevant prior medical records from the retrieved prior medical orders based upon the selected patient and selected one or more prior medical orders, and a fifth executable portion for delivering the relevant prior medical records to one or more remote computers.

### BRIEF DESCRIPTION OF THE DRAWINGS

The features and advantages of this disclosure, and the manner of attaining them, will be more apparent and better understood by reference to the accompanying drawings, wherein:

FIG. 1 shows a flowchart of an exemplary method of delivering relevant medical information according to at least one embodiment of the present disclosure.

FIG. 2 shows a flowchart of an exemplary method of delivering relevant medical information according to at least one embodiment of the present disclosure.

FIGS. 3-9 illustrate a graphic user interface of the RPE tool according to at least one embodiment of the present disclosure.

### DETAILED DESCRIPTION

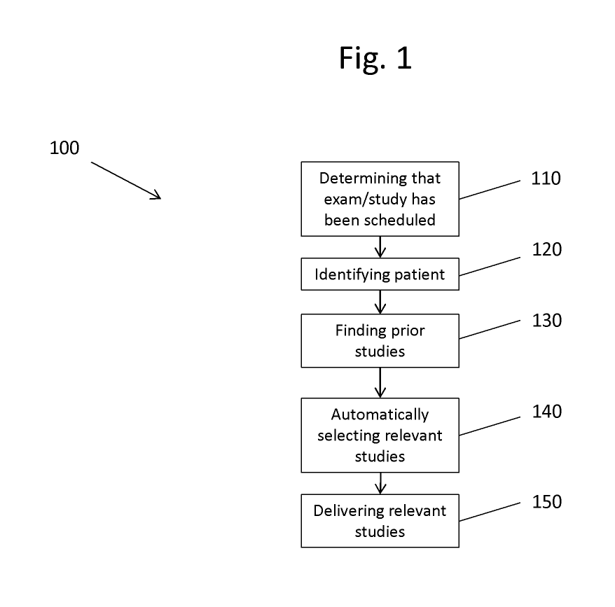

For the purposes of promoting an understanding of the principles of the present disclosure, reference will now be made to the variations and/or embodiments illustrated in the drawings, and specific language will be used to describe the same. It will nevertheless be understood that no limitation of the scope of this disclosure is thereby intended, FIG. 1 shows a method of delivering relevant medical information 100. As shown in FIG. 1, the method 100 includes the step of determining that an exam/study has been scheduled 110 and identifying the patient having the exam/study 120. The method 100 also includes the steps of finding all studies done for the patient 130 and automatically selecting relevant studies from a list of all studies found 140. The method 100 further includes the step of delivering relevant studies to a final destination 150. As described further below, each step of method 100 may be performed automatically by a computer.

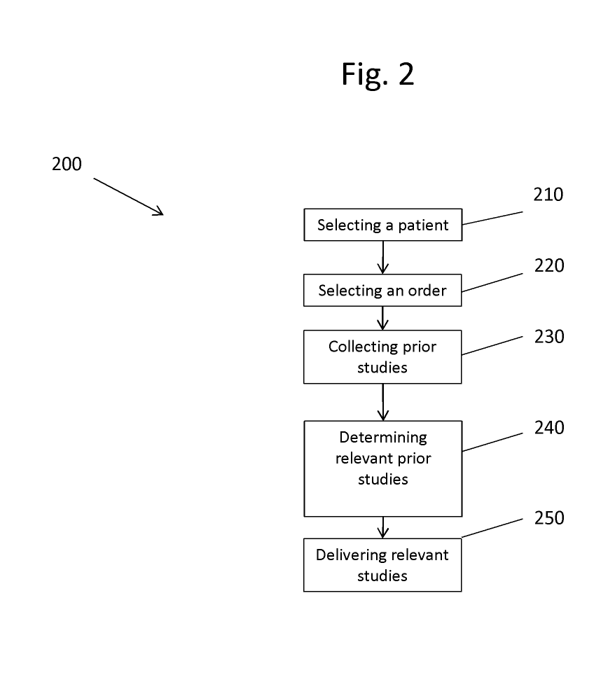

FIG. 2 shows a method of delivering relevant medical information 200. As shown in FIG. 2, the method 200 includes the step of selecting a patient for analysis 210 and selecting an order 220. The method 200 also includes the steps of collecting prior studies for the patient 230, determining relevant prior studies 240, and delivering relevant studies to a final destination 250. As described further below, one or more of the steps of the method may be performed automatically by a computer.

The methods 100, 200 may be carried out by various systems. One system that may be used to carry out the methods 100, 200 is referred to herein as a Relevant Prior Engine (RPE). The RPE is typically designed to “hang” off of an existing system and provide prior study gathering capabilities over various networks, such as, for example, a wide area network. When coupled with an mPlexus DNA grid based archive system or similar system, an organization can build a system or scale an existing system to regional, national or even worldwide capabilities. RPE supports clustering and load balancing for high availability and speed. The RPE may include the integration of a commercially available HL7 interface engine that allows the RPE to parse and massage HL7 data coming from a Radiology Information System (RIS) as well as provide outbound HL7 message capabilities. The RPE may be built on top of an mPlexus DICOM router code base or similar device.

The RPE can move prior studies in an automated fashion based on a variety of triggering events, such as, for example, medical order messages (e.g., radiology orders) that have been dispatched or announced on a network (e.g., Health Level Seven (HL7)) and are intercepted by an HL7 interface engine or other interface engine or system. The RPE may be triggered by the receipt of a newly sent study by a DICOM router such as the DICOM extender which has been configured to parse the DICOM Header and to develop an HL7 message that is sent to the RPE. The RPE may be triggered by querying the DICOM Modality Worklist of a given PACS and using the DICOM information of a study to be performed to develop and HL7 message to send to the RPE. Of course, other triggering events may be used.

After receiving each medical order message, the HL7 engine may parse the medical order message and decode it such that RPE may easily understand and classify it. The analysis of the medical order message can include determining the name, date of birth, medical record number, address, social security number, and other related information of the patient. It should be noted that the analysis of order messages may be performed at scheduled times, such as, for example, one week after receipt of the order message.

The analysis of the medical order message may also include determining the specific mPlexus Procedural Terminology (mPT) code. The mPT code is determined by performing searches of various key words that uniquely identify the body part, modality, contrast, laterality, and the like. Based upon the determined mPT code, the RPE may determine what other mPT codes are relevant in view of the best practice criteria that is stored in the RPE.

After analyzing the medical order message, and referencing a Master Patient Index (MPI) if one is relevant, the RPE may search all available or configured archives for studies that match the patient name, demographics, mPT codes, and the like using the list of DICOM devices that have been specified by the customer. The search may involve various systems, such as those in the local area and any institution or archive that may be considered within the referral chain for that institution and for that particular patient. RPE may have a tiered approach to searching for studies that will enable it to deliver studies quickly. For example, if a study exists in 2 places, RPE may fetch it from the system that will get it the fastest. If a study exists in the local PACS already, RPE may not attempt to fetch it from another system. In at least one embodiment, based upon the determined mPT code and relevant mPT codes, a list of prior studies may be returned from the source PACS.

After RPE obtains a list of all studies available for the patient, it may parse the list using an algorithm and develop a list of all “relevant” prior exams for the specific patient. The parameters of the algorithm may be configurable by the customer to meet their individual preferences or a default may be provided. The algorithm generates an importance weighted result based upon multiple factors such as, for example, date of study (most recent generally most important), type of study including modality, and the history (from referring physician or associated EMR, and ultimately based on the results reported on the prior studies). RPE may deliver a configurable number of the relevant prior studies to a destination (e.g., local PACS of a medical professional). For example, the default number of studies may be the 5 most relevant studies beginning with the most recent. It should be noted that all parameters of the algorithm may be configurable.

As mentioned above, the relevant prior studies are sent to the destination PACS. When RPE has found the prior studies to send to the final destination, it may send them based on the configured destinations. This could be a single PACS or multiple PACS or workstations depending on the individual customer network. The use of the RPE algorithm greatly decreases the network traffic by delivering only the relevant studies and not the patients entire history of records, thus decreasing the number of prior studies that are delivered. It may also compress and encrypt the studies before sending them. The RPE also may alter the header information on the medical record/image set, It should be noted that the RPE may send the prior studies by any secure method that is HIPPA compliant, but for medical images the most commonly used method is via secure DICOM transfer.

As mentioned above, the RPE may be integrated with an HL7 interface engine. The following examples of operation of the RPE involve interaction with an HL7 interface engine. It should be noted that a different interface engine or triggering method or system may be used as an alternative to the HL7 interface engine or in addition to it.

### Example 1

### HL7 Order Triggering an Immediate Copy of Relevant Prior Studies

An HL7 radiology order is intercepted by the RPE via an HL7 interface engine. This engine is at least partly responsible for parsing the HL7 message and decoding it in a manner that makes it easy for the RPE to understand and classify. The scan or analysis may be scheduled to be completed within 24 hours. If so, the HL7 order scheduler dispatches it to the RPE engine immediately for processing. From the HL7 order, the patient ID and/or additional relevant information is determined. Examples: Medical Record Number (MRN), Patient Name, DOB, SSN, Address, etc. From the HL7 order, the specific mPT code is determined by performing searches of various key words that uniquely identify the Body part, Modality, Contrast, Laterality. The mPT code allows the RPE to determine what other mPT codes are relevant based on the best practice criteria that is stored in a matrix like configuration. The matrix may have the option of being dynamically configured via an internal mPlexus tool.

The RPE queries for prior studies from the source PACS by either performing a real time query of the PACS for that patient name or MRN or by referencing a previously established database that has been developed by “crawling” or “indexing” the PACS at the time of set up of the RPE. A list of prior studies is returned which reflects the content of the source PACS and the study descriptions are tested using a set of complex pattern matching algorithms to determine relevant matches based on the original order's mPT code. By limiting the searching to mPT codes that are only relevant to this order, the system, method, and computer readable medium of the present disclosure reduce the amount of processing work performed in subsequent steps and reduce to the minimum necessary, both the number of queries performed against the PACS and the network traffic. The matching relevant prior studies may be stack ranked by a set of post processing rules that are applied after relevant studies are identified. These rules may incorporate the ideas that most recent studies are most relevant but also that oftentimes the most remote study may be very useful for determining the course of disease from first discovery. Additionally, the rules may incorporate the idea that generally a study of matching modality may be most relevant, but this may not be true if the most recent is a complimentary modality of the same body part. Based on a configurable parameter, the ‘n’ Recent and ‘m’ Non-Recent studies will be marked for delivery to the destination PACS system. For all studies that are marked for delivery to the destination PACS, a DICOM query will be made to determine if the study is already on the destination PACS and if it contains the same # of DICOM images as the one on the source PACS.

For every study that doesn't exist on the destination PACS, the RPE may, if needed, send an HL7 order to the destination RIS so that it can enable the destination PACS to receive the studies as well as trigger any logic specific to the destination RIS. After a configurable delay period, the studies from the previous step are sent to the destination PACS. Since the RPE system most often starts to move studies to the destination PACS system prior to the new study being complete, the new study should finish after the relevant prior studies. The new study oftentimes is sent to the destination PACS by the Radiologic Technologist electronically pushing the study or by the source PACS forwarding the study, In at least one triggering method, this transferring of the current study through a DICOM Router may trigger the RPE functionality, When the radiologist views the current study from the destination PACS, the relevant prior studies are available, thus allowing a final report to be created.

### Example 2

### HL7 Order Triggering A Delayed Copy Of Relevant Prior Studies.

An HL7 radiology order is intercepted by the RPE via an HL7 interface engine. This engine is at least partly responsible for parsing the HL7 message and decoding it in a manner that makes it easy for the RPE to understand and classify. From the HL7 order, the patient ID and/or additional relevant information is determined. Examples: MRN, Patient Name, DOB, SSN, Address, etc. The appointment to perform the scan is one week into the future, so the RPE stores the HL7 order into a table for later processing in approximately 1 week. One week passes and the HL7 order scheduler pulls the order from the table and dispatches it to the RPE engine for processing, typically within 24 hours of the scan date.

From the HL7 order, the specific mPT code is determined by performing searches of various key words that uniquely identify the Body part, Modality, Contrast, Laterality. The mPT code allows the RPE to determine what other MPT codes are relevant based on the best practice criteria that is stored in a matrix like configuration. The matrix may have the option of being dynamically configured via an internal mPlexus tool, The RPE queries for prior studies from the source PACS that may be preconfigured into an RPE database, A list of prior studies are returned from the source PACS and the study descriptions are tested using a set of complex pattern matching algorithms to determine relevant matches based on the original order's mPT code. By limiting the searching to mPT codes that are only relevant to this order, we reduce the amount of processing, network traffic, and PACS queries.

The matching relevant prior studies will be stack ranked by a set of post-processing rules. Based on a configurable parameter, the ‘n’ Recent and ‘m’ Non-Recent studies will be marked for delivery to the destination PACS system. For all studies that are marked for delivery to the destination PACS, a DICOM query will be made to determine if the study is already on the destination PACS and if it contains the same # of DICOM images as the one on the source PACS. For every study that doesn't exist on the destination PACS, the RPE will send an HL7 order to the destination RIS so that it can enable the destination PACS to receive the studies as well as trigger any logic specific to the destination RIS.

After a configurable delay period, the studies from the previous step are sent one at a time to the destination PACS. Since the RPE system started to move studies to the destination PACS system prior to the new study being complete, the new study should finish after the relevant prior studies. The study is, most often, sent to the destination PACS by the Radiologic Technologist pushing the study. When the radiologist views the current study from the destination PACS, the relevant prior studies are available, thus allowing a final report to be created.

### Example 3

### HL7 Order Cancel and Consequences

An HL7 radiology order is intercepted by the RPE via an HL7 interface engine. This engine is at least partly responsible for parsing the HL7 message and decoding it in a manner that makes it easy for the RPE to understand and classify. From the HL7 order, the patient ID and/or additional relevant information is determined. Examples: MRN, Patient Name, DOB, SSN, Address, etc. The appointment to perform the scan is one week into the future, so the RPE stores the HL7 order into a table for later processing in approximately 1 week, After the original order was received, an HL7 order cancelling the original order is received, The corresponding entry in the RPE is removed and no relevant prior studies will be copied to the destination PACS,

### Example 4

### HL7 Order Update and Consequences

An HL7 radiology order is intercepted by the RPE via an HL7 interface engine. This engine is at least partly responsible for parsing the HL7 message and decoding it in a manner that makes it easy for the RPE to understand and classify. From the HL7 order, the patient ID and/or additional relevant information is determined. Examples: MRN, Patient Name, DOB, SSN, Address, etc. The appointment to perform the scan is one week into the future, so the RPE stores the HL7 order into a table for later processing in approximately 1 week. 24 hours after the original order was received, an HL7 order update order is received that changes the scan date to 2 days after the original order was received. The corresponding entry in the RPE is updated to reflect the new time to start copying the relevant prior studies, Approximately 24 hours prior to the new order date, the RPE begins to process it in a similar manner as described above in HL7 order triggering a delayed copy of relevant prior studies, starting at step #4.

### Example 5

### HL7 Order Update/Change and Consequences

An HL7 radiology order is intercepted by the RPE via an HL7 interface engine, This engine is at least partly responsible for parsing the HL7 message and decoding it in a manner that makes it easy for the RPE to understand and classify. From the HL7 order, the patient ID and/or additional relevant information is determined. Examples: MRN, Patient Name, DOB, SSN, Address, etc. The appointment to perform the scan is one week into the future, so the RPE stores the HL7 order into a table for later processing in approximately 1 week, 24 hours after the original order was received, an HL7 order update reorder is received that changes the scan from a CAT scan of the head to an MRI of the brain. The corresponding entry in the RPE is updated to reflect the new scan to start copying the relevant prior studies. Approximately 24 hours prior to the order date, the RPE begins to process it in a similar manner as described above in HL7 order triggering a delayed copy of relevant prior studies, starting at step #4.

A computer-readable medium, such as a non-volatile storage medium, may comprise the steps of the methods 100, 200 for delivering relevant medical information described above, For instance, the method 200 may be incorporated into a computer program to allow a user to select a patient for analysis and a medical order, automatically retrieve prior medical records of the patient, automatically determine relevant prior medical records from the retrieved prior medical records based upon the selected patient and the selected medical order, and automatically deliver the relevant prior medical records to a destination. The computer program may be generated in any software language or framework such as C#, COBOL, C++, Microsoft®.NET Framework or the like.

The computer-readable medium for performing the embodiments of the present disclosure may include computer-readable program code portions, such as a series of computer instructions, embodied in the computer-readable medium. It should be understood that the computer-readable program code portions may include separate executable portions for performing distinct functions to accomplish embodiments of the present disclosure. Additionally, or alternatively, one or more of the computer-readable program portions may include one or more executable portions for performing more than one function to thereby accomplish embodiments of the process of the present disclosure.

In conjunction with the computer-readable medium, a computer that includes a processor, such as a programmable-variety processor responsive to software instructions, a hardwired state machine, or a combination of these may be used to carry out the method disclosed above. Such computers may also include memory, which in conjunction with the processor is used to process data and store information. Such memory can include one or more types of solid state memory, magnetic memory, or optical memory, just to name a few. By way of non-limiting example, the memory can include solid state electronic random access memory (RAM); sequential access memory (SAM), such as first-in, first-out (FIFO) variety or last-in, first-out (LIFO) variety; programmable read only memory (PROM); electronically programmable read only memory (EPROM); or electronically erasable programmable read only memory (EEPROM); an optical disc memory (such as a DVD or CD-ROM); a magnetically encoded hard disc, floppy disc, tape, or cartridge media; or a combination of these memory types. In addition, the memory may be volatile, non-volatile, or a hybrid combination of volatile and non-volatile varieties. The memory may include removable memory, such as, for example, memory in the form of a non-volatile electronic memory unit; an optical memory disk (such as a DVD or CD ROM); a magnetically encoded hard disk, floppy disk, tape, or cartridge media; or a combination of these or other removable memory types.

The computers described above may also include a display upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Such computers may also include one or more data entry, such as, for example, a keyboard, keypad, pointing device, mouse, touchpad, touchscreen, microphone, and/or other data entry means known in the art. Each computer also may comprise an audio display means such as one or more loudspeakers and/or other means known in the art for emitting an audibly perceptible output.

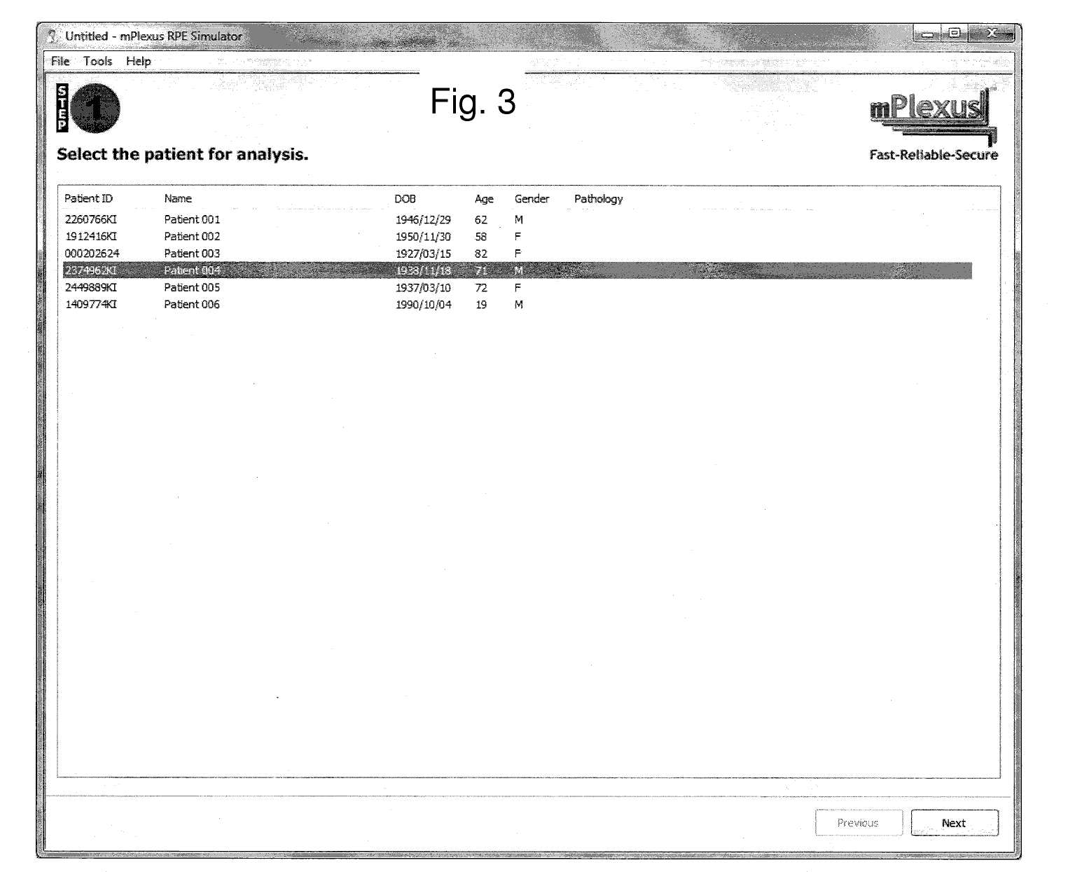

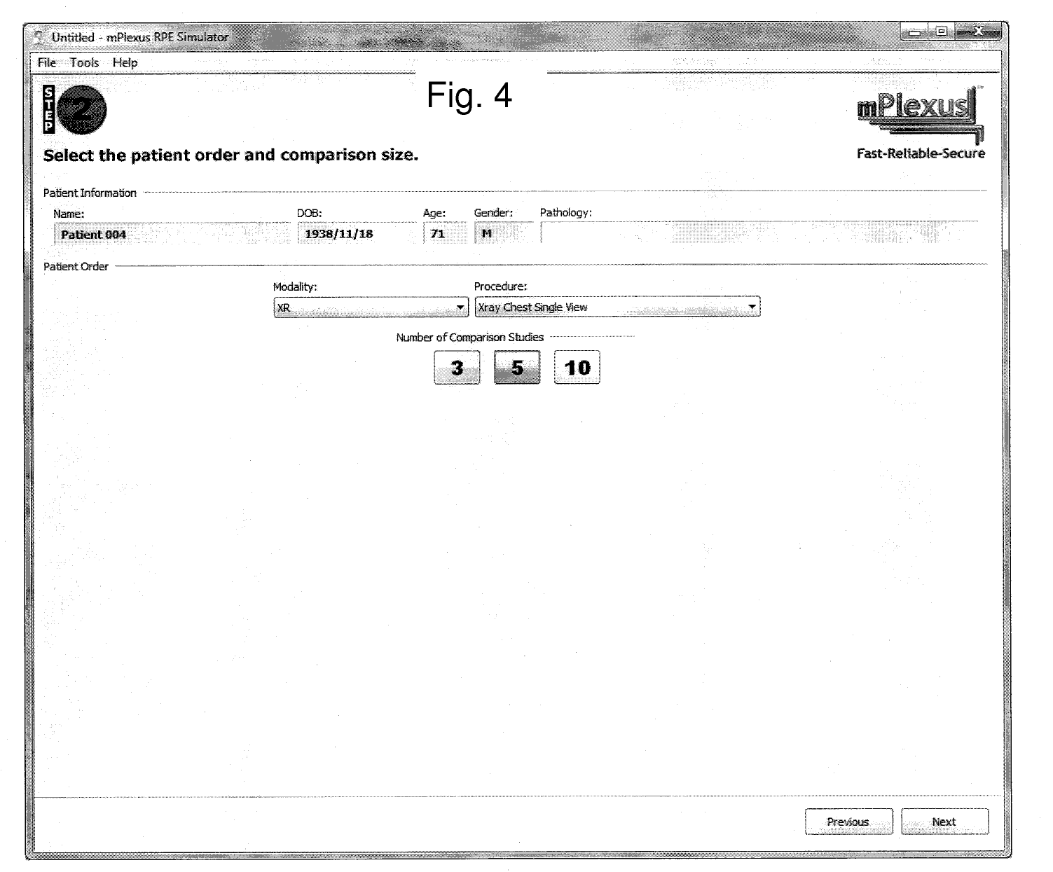

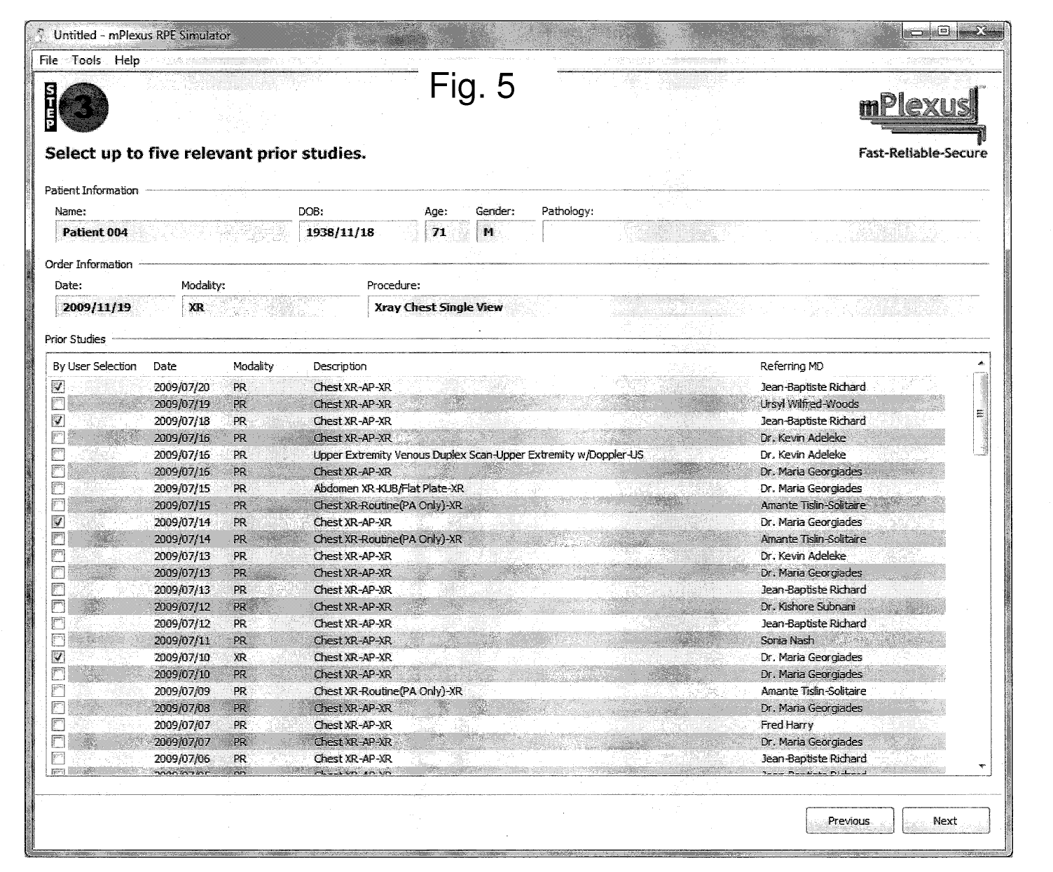

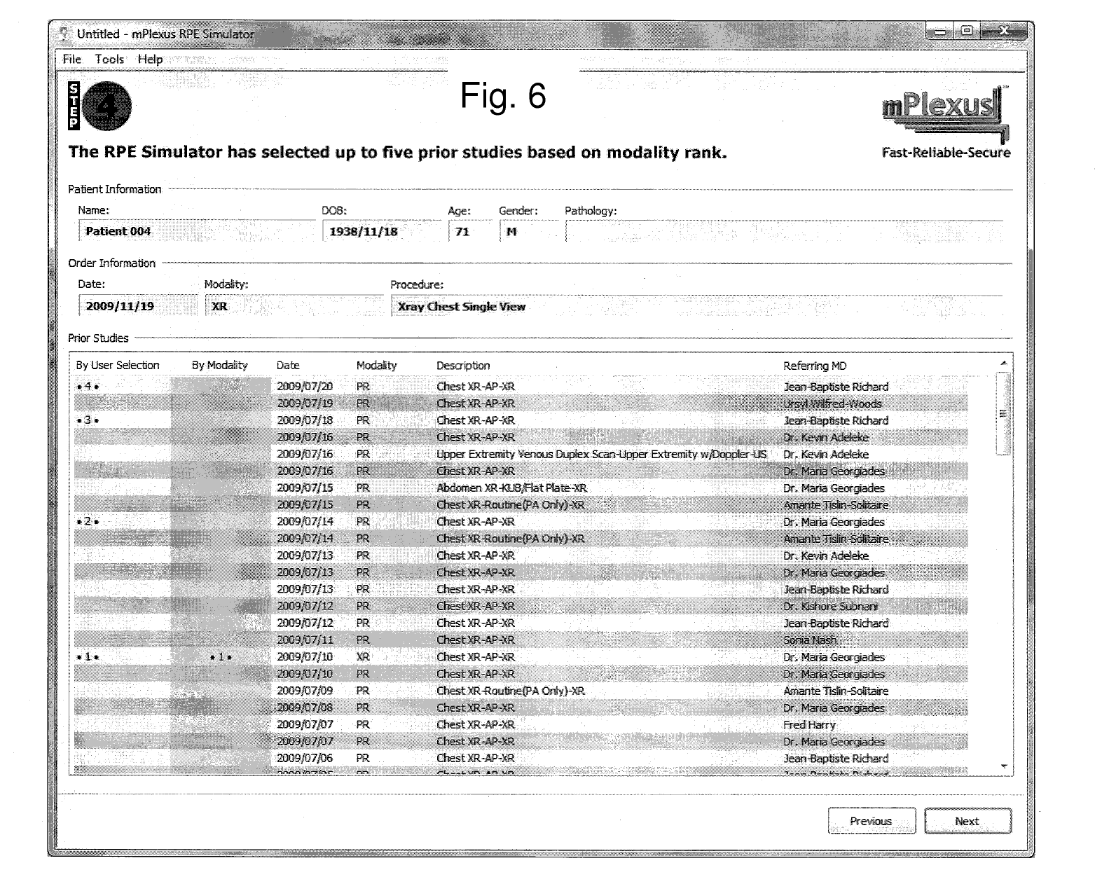

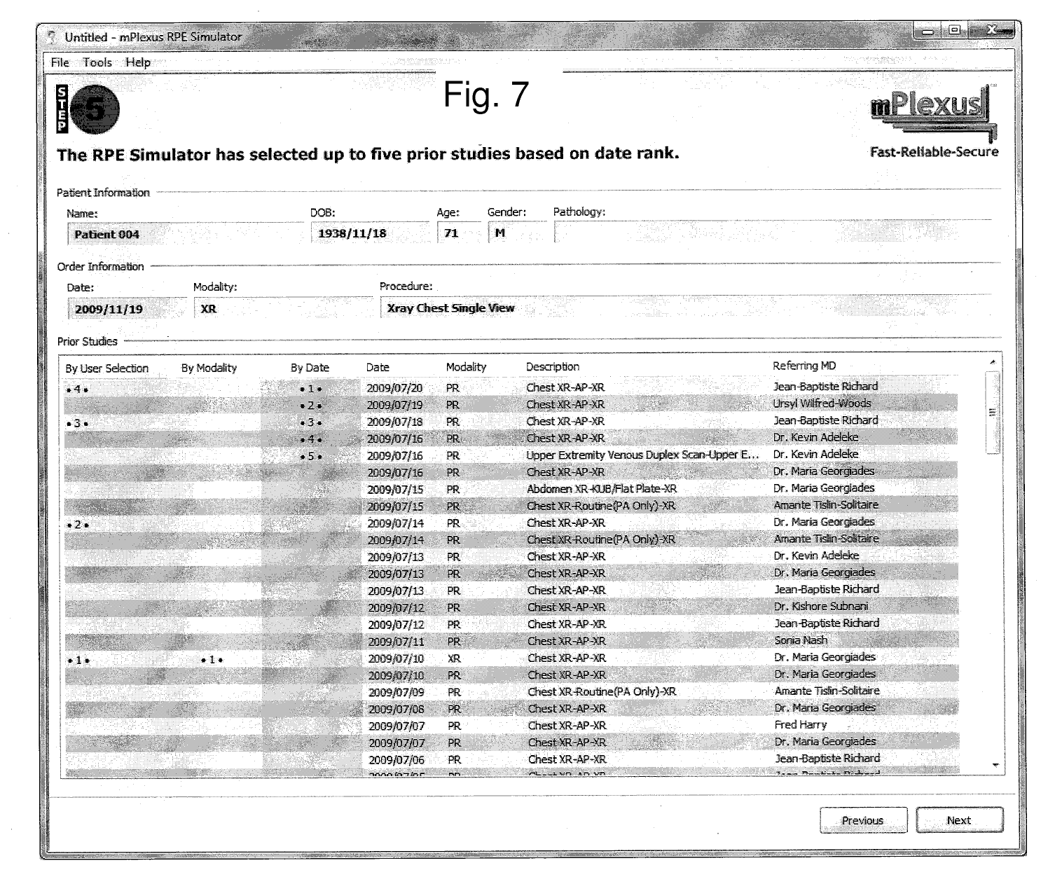

The following discussion relating to FIGS. 3-9 describes an example of a computer-readable medium that comprises the steps of the method described above. As shown in FIG. 3, selecting a patient for analysis may include choosing a particular patient from a listing of patients displayed on a computer. The listing of patients may be generated from various databases and the like. FIG. 4 shows a screen shot including patient information from the patient chosen in FIG. 3. FIG. 4 also shows drop down menus for selecting patient order information (namely, modality and procedure). The user may choose an order for the particular patient. FIG. 4 also shows choices for the number of studies to be compared. Of course, the number of studies to be compared may be entered in various other ways. FIG. 5 shows an example of a computer generated list of prior studies, where the list includes user selection boxes next to each prior study. FIG. 6 shows the relevance rankings of prior studies based on user selection and modality rank. FIG. 7 shows the relevance rankings of prior studies based on user selection, modality rank, and date rank. In other systems, relevant prior studies were based only on one of user selection, modality rank, or date rank. As mentioned above, the present disclosure describes using multiple factors to determine the relevant prior studies.

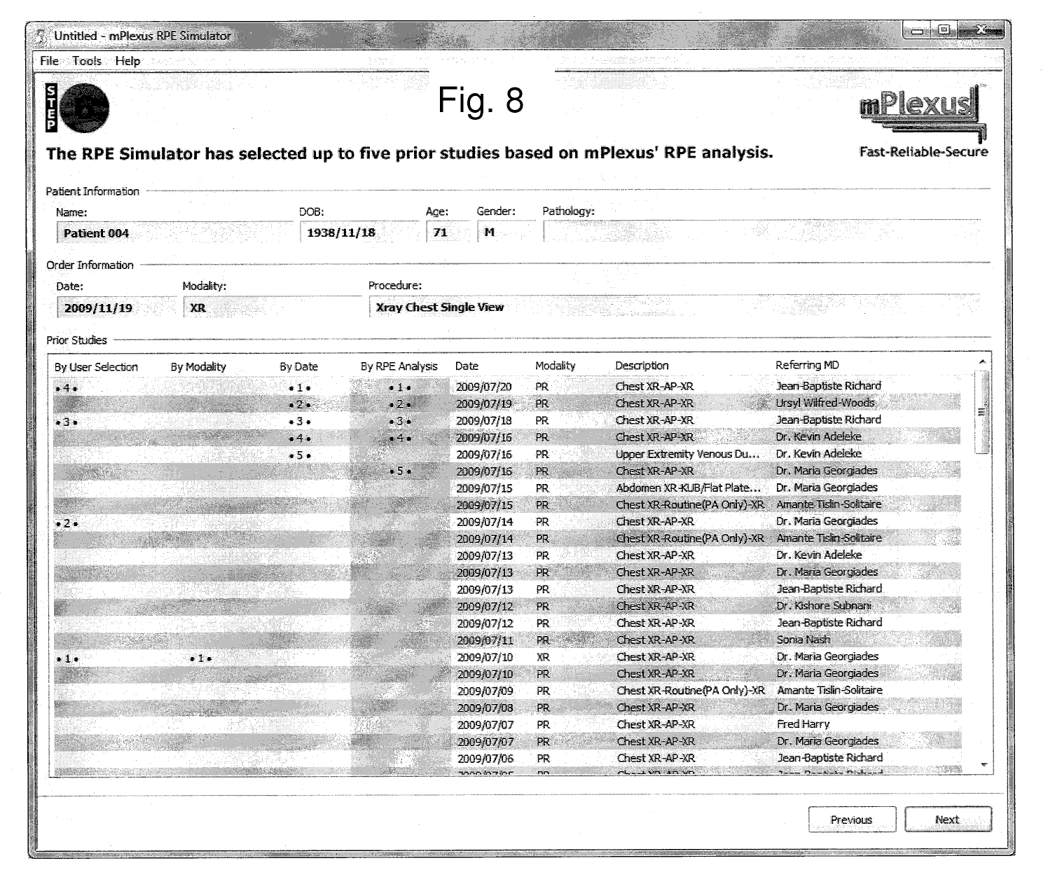

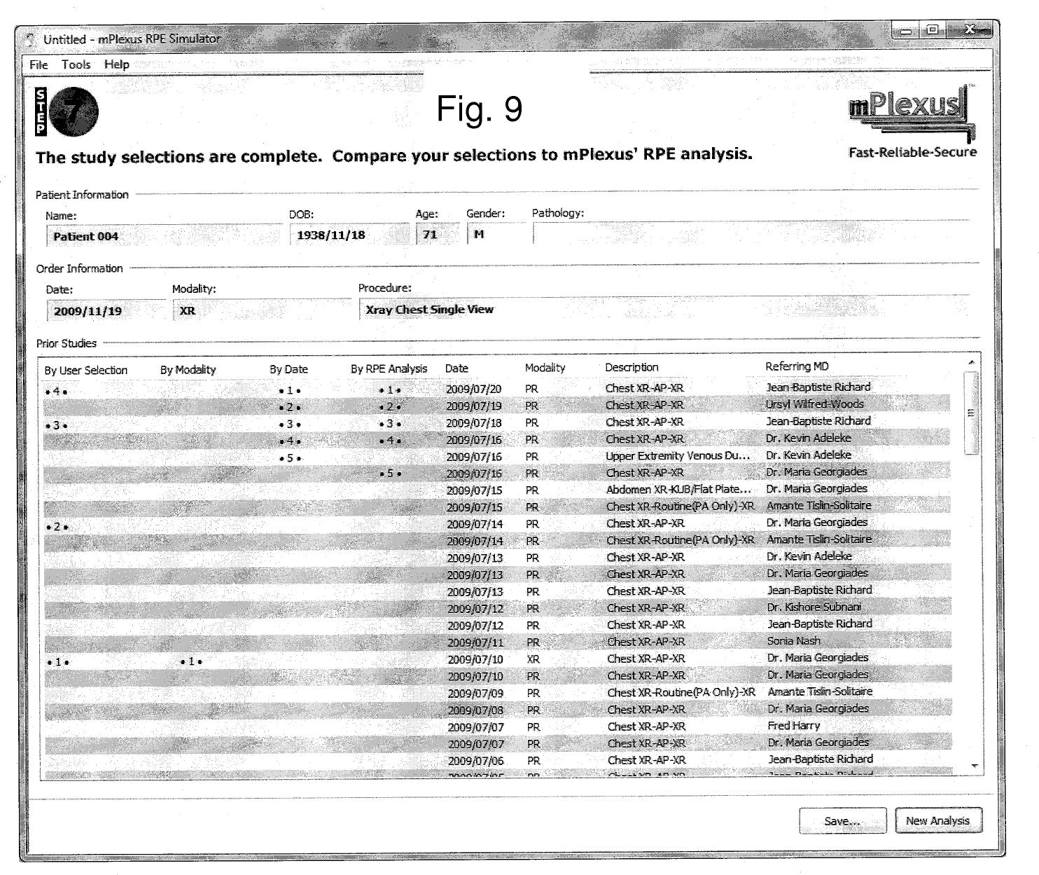

FIG. 8 includes the RPE relevance rankings of prior studies using an algorithm. As described above, the parameters of the algorithm may be configurable by the customer to meet their individual preferences or a default may be provided. The algorithm generates an importance weighted result based upon multiple factors such as date of study (most recent generally most important), type of study including modality, and eventually the history (from referring physician or associated EMR, and ultimately based on the results reported on the prior studies). It should be noted that all parameters of the algorithm may be configurable. FIG. 9 shows the prior studies list with all of the relevance rankings (user selection, modality, date, and RPE analysis). As shown in FIG. 9, the prior ways of finding relevant prior studies (user selection, modality, or date) provide different results compared to the RPE relevance ranking of the present disclosure. In particular, by considering multiple factors, the RPE relevance ranking yields more accurate results compared to a relevancy selection based only on user selection, modality, or date.

After determining which prior studies are relevant, the relevant prior studies are sent to the destination PACS. This could be a single PACS or multiple PACS or workstations depending on the individual customer network. As stated previously, the use of the RPE algorithm greatly decreases the network traffic by decreasing the number of prior studies that are delivered. It may also compress and encrypt the studies before sending them.

### Example of Radiology Order Processing for Relevancy Testing

Scan appropriate HL7 string data field(s) to match terminology to determine body group and the associated mPT (mPlexus Procedural Terminology). Scan HL7 string data field(s) to match terminology to determine Modality (CT, MR, etc.). Scan HL7 string data field(s) to match terminology to determine Contrast (with, without). Scan HL7 string data field(s) to match terminology to determine Laterality (left, right, etc.). Laterality might include states such as Both, Not Applicable, and Unknown. For the above steps, configuration may allow entry of exact terminology used in customer system, if known, to reduce processing time by reducing the number of terminology matching tests.

### Example of Algorithm for Relevancy Determination

The algorithm may begin by looking down the column within a matrix of weighting factor values that corresponds to determined Radiology Order mPT. The rows of the matrix also represents mPlexus Procedural Terminologies. All rows with non-zero values indicate Potentially Relevant mPTs. The matrix may be reduced by focusing on common studies, such as: Night-time work: Head CT, PE study, abdomen pelvis CT; Ultrasound: Pelvis, gallbladder, lower extremity/vein; X-ray: Chest x-ray, abdominal x-ray, hip, random extremities (ankle, wrist, etc.); X-ray; thoracic spine, lumbar spine, cervical spine, pelvis; and Nuclear medicine studies (I-HDA scan): gallbladder. Scan appropriate DICOM header string data field(s) to match terminology to determine body group and the associated mPT (mPlexus Procedural Terminology), only testing for Potentially Relevant priors mPTs.

Only continue with the following steps for matching priors. Scan DICOM header string data field(s) to match terminology to determine Modality (CT, MR, etc). Scan DICOM header string data field(s) to match terminology to determine Contrast (with, without). DICOM header string data field(s) to match terminology to determine Laterality (left, right, etc.). For the above string matching steps, configuration may allow entry of exact terminology used in customer system, if known, to reduce processing time by reducing the number of terminology matching tests. When a Radiology Order specifies laterality, eliminate priors that do not match Laterality criteria.

Modality relevance testing. Weighting factors may be applied to modality on a universal basis, or perhaps on a per mPT basis. Specific logic conditions may be applied in addition to weighting.

Contrast relevance testing. Weighting factors may be applied to contrast on a universal basis, or perhaps on a per mPT basis. Specific logic conditions may be applied instead of, or in addition to, weighting.

Time-based relevance testing: Studies less than a configured age will be classified as Recent (<2 years for example) and older studies will be classified as Non-Recent. The ‘n’ top weighted Recent studies will be declared Relevant Priors. The ‘m’ top weighted Non-Recent studies will be declared Relevant Priors. Values suggested in discussion are n=2 and m=1, but this would be configurable, perhaps on a per mPT basis. Additional special-case rules might be applied to certain Order mPTs in the final selection of Relevant Priors if proven to be necessary to capture the selection rules used by a human expert, Candidate Priors can be eliminated from further testing/matching whenever we can determine associated images are not present.

### Example

### Prior Studies Report that is Sent Via Email from the RPE Server

Create a report that includes a listing of all prior studies that were eligible and the final list of studies that were sent to the destination PACS. This would be detailed for every HL7 radiology order received. This report should be sent out periodically as a batch report or each individual RPE report could be attached to its associated studies as a dicom element. If a batch report, it should be a configurable # of days. It should include all relevant studies that were moved in the reporting time period. Example: A 7 day reporting interval would indicate that all studies and their corresponding relevant priors that were copied by the RPE in the last 7 days prior to report generation would be included.

### General Requirements for Analysis

Specifications (including HL7 version, vendor-specific or site-specific field usage, etc,) for relevant HL7 messages used between systems, or for HL7 message sources we will have feeds from. Enumerate any relevant HL7 MSH-9 “message types” and “trigger events”. Actual HL7 message traffic for each of the above (data will ideally include orders for patients represented in the sample DICOM header data). Specifications (including HL7 version, vendor-specific or site-specific field usage, etc.) and sample messages for HL7 messages we are to generate (might be covered above if we are simulating orders that satisfy the message output specification for an existing source system.) DICOM header data; specification for PACS and any site specific fields/usage, actual sample data (especially to support patient matching tests; data should emphasize patients with multiple priors to provide good RPE algorithm test cases.)

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein and in the appended documents represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

That which is claimed is:

1. A method of delivering relevant medical information using a computer, the method comprising:
determining that a medical order has been scheduled or completed for a patient;
identifying the patient that is the subject of the medical order;
finding prior medical records of the patient;
automatically determining relevant medical records from the prior medical records of the patient based upon the medical order; and
delivering the relevant medical records to one or more remote computers.

2. The method of claim 1, wherein the step of determining that a medical order has been scheduled or completed comprises intercepting a medical order message that has been dispatched or announced on a network.

3. The method of claim 2, wherein the step of identifying the patient comprises analyzing each intercepted medical order message to determine one or more of name, date of birth, address, and social security number of the patient.

4. The method of claim 1, wherein the step of finding prior medical records comprises searching archives for medical records that match one or more of the patient's name, demographics of the patient, and one or more medical type codes.

5. The method of claim 1, wherein the step of finding prior medical records comprises contacting remote medical institutions.

6. The method of claim 1, wherein the step of automatically determining relevant medical records comprises ranking each prior medical record based upon one or more of date of medical record, type of medical record, and referring physician.

7. The method of claim 6, wherein the step of automatically determining relevant medical records comprises automatically choosing a predetermined number of medical records based upon a resulting rank of the prior medical records.

8. The method of claim 1, wherein the step of delivering the relevant medical records comprises transferring files using one or more of email and file transfer protocol.

9. The method of claim 1, wherein the step of delivering the relevant medical records comprises transferring files based upon a schedule.

10. A method of delivering relevant medical information using a computer, the method comprising:
selecting a patient for analysis;
selecting a medical order;
retrieving prior medical records of the patient;
automatically determining relevant prior medical records from the retrieved prior medical records based upon the selected patient and the selected medical order; and
delivering the relevant prior medical records to a destination.

11. The method of claim 10, wherein the step of determining relevant prior medical records comprises application of a ranking program based upon one or more of date of study, type of study, and referring physician.

12. The method of claim 11, wherein the step of selecting relevant prior medical records comprises automatically choosing a predetermined number of prior medical records based upon a resulting rank of the prior studies.

13. The method of claim 10, wherein the step of delivering relevant prior medical records comprises transferring files using one or more of email and file transfer protocol.

14. The method of claim 10, wherein the step of delivering relevant prior medical records comprises transferring files based upon a schedule.

15. A computer-readable medium with a computer program for delivering relevant medical information, the computer-readable medium comprising code portions stored therein, the computer-readable medium code portions comprising:
a first executable portion for selecting a patient for analysis;
a second executable portion for selecting one or more prior medical orders;
a third executable portion for retrieving prior medical records of the patient;
a fourth executable portion for determining relevant prior medical records from the retrieved prior medical orders based upon the selected patient and selected one or more prior medical orders; and
a fifth executable portion for delivering the relevant prior medical records to one or more remote computers.

16. The computer-readable medium of claim 15, wherein the first executable portion is configured to allow a user to choose a patient from a list.

17. The computer-readable medium of claim 15, wherein the fifth executable portion is configured to transfer files using one or more of email and file transfer protocol.

18. The computer-readable medium of claim 15, wherein the fifth executable portion is configured to transfer files based upon a schedule.

19. The computer-readable medium of claim 15, wherein the third executable portion is configured to electronically contact remote medical institutions to determine if the remote medical institutions contain prior medical records of the patient.

20. The computer-readable medium of claim 15, wherein the fourth executable portion is configured to apply a ranking program to the retrieved prior medical records of the patient based upon one or more of date of order, type of order, and referring physician.
